(19) United States
(12) Patent Application Publication
(10) Pub. No.: US 2026/0084448 A1
(43) Pub. Date: Mar. 26, 2026

(54) PRINTER APPARATUS

(71) Applicant: TOSHIBA TEC KABUSHIKI KAISHA, Tokyo (JP)

(72) Inventors: Tsuyoshi Sanada, Susono Shizuoka (JP); Kenji Eoka, Sunto Shizuoka (JP); Yuji Kawamorita, Mishima Shizuoka (JP); Tsuyoshi Shimada, Mishima Shizuoka (JP)

(21) Appl. No.: 19/246,797

(22) Filed: Jun. 24, 2025

(30) Foreign Application Priority Data
Sep. 25, 2024 (JP) 2024-165873

(51) Int. Cl. B41J 13/10; B41J 3/407; B41J 11/70; B41J 13/22

(52) U.S. Cl. CPC B41J 13/106; B41J 3/407; B41J 11/706; B41J 13/22

(57) ABSTRACT

A printer that makes it less likely for cut and discharged paper to fall by a structure that can be formed by a wear-resistant component. The printer includes: a printing portion configured to perform printing while pulling out and conveying strip-shaped paper; a cutting portion configured to cut the paper; a support portion provided downstream of the cutting portion in the paper conveying direction and configured to come into contact with a second surface that is a back surface of the first surface to support the paper, the support portion being inclined such that a leading end portion of the paper, which moves along with conveyance, is displaced in a direction from the second surface toward the first surface; and a holding portion provided downstream of the cutting portion in the paper conveying direction and configured to press the first surface of the paper supported by the support portion.

### CROSS-REFERENCE TO RELATED APPLICATION

This application is based upon and claims the benefit of priority from Japanese Patent Application No. 2024-165873, filed on Sep. 25, 2024, the entire contents of which are incorporated herein by reference.

### FIELD

Embodiments described herein relate generally to a printer apparatus, a method for a printer, and thermal printer.

### BACKGROUND

In related art, there is a printer apparatus that pulls out paper from roll paper and performs printing output. Such a printer apparatus is used, for example, for printing and issuing receipts. The receipt is cut each time the receipt is issued. In order to make it less likely for the receipt to fall from a paper discharge port, the printer apparatus includes a support portion that supports the cut receipt from below and a member for holding the paper onto the support portion. The member typically has a brush shape, and tips of bristles constituting the brush slide on an upper surface of the discharged paper.

Since the brush-shaped member as described above wears out at the tips of the bristles due to sliding on the paper, the member is a consumable and thus requires regular replacement (maintenance).

### DESCRIPTION OF THE DRAWINGS

FIG. 1 is a perspective view showing an example of appearance of a printer apparatus according to an embodiment.

FIG. 2 is a perspective view showing the printer apparatus in a state in which a housing is opened.

FIG. 3 is a cross-sectional view showing an example of an internal structure of the printer apparatus.

FIG. 4 is a cross-sectional view showing the printer apparatus in the state in which the housing is opened.

FIG. 5 is an enlarged cross-sectional view of a portion around a paper discharge port.

FIG. 6 is an enlarged cross-sectional view of the portion around the paper discharge port.

FIG. 7 is a schematic view showing an operation of a swing portion.

FIG. 8 is a perspective view showing an example of appearance of the swing portion.

FIG. 9 is a perspective view showing another example of the appearance of the swing portion.

FIG. 10 is a perspective view showing another example of the appearance of the swing portion.

FIG. 11 is an enlarged cross-sectional view of the portion around the paper discharge port.

### DETAILED DESCRIPTION

A problem to be solved by the disclosure is to provide a printer apparatus that makes it less likely for cut and discharged paper to fall by a structure that can be formed by a wear-resistant component.

In general, according to one embodiment, a printer apparatus includes: a printing portion configured to perform printing while pulling out and conveying strip-shaped paper from roll paper formed by winding the paper with a first surface facing outward; a cutting portion provided downstream of the printing portion in a paper conveying direction and configured to cut the paper; a support portion provided downstream of the cutting portion in the paper conveying direction and configured to come into contact with a second surface that is a back surface of the first surface to support the paper, the support portion being inclined such that a leading end portion of the paper, which moves along with conveyance, is displaced in a direction from the second surface toward the first surface; and a holding portion provided downstream of the cutting portion in the paper conveying direction and configured to press the first surface of the paper supported by the support portion. In another embodiment, a method for a printer involves printing while pulling out and conveying strip-shaped paper from roll paper formed by winding the strip-shaped paper with a first surface facing outward; cutting the strip-shaped paper using a cutting component provided downstream of a printing component in a paper conveying direction; contacting a support component provided downstream of the cutting component in the paper conveying direction with a second surface that is a back surface of the first surface to support the strip-shaped paper, the support component being inclined such that a leading end portion of the strip-shaped paper, which moves along with conveyance, is displaced in a direction from the second surface toward the first surface; and pressing the first surface of the strip-shaped paper supported by the support component using a holding component provided downstream of the cutting component in the paper conveying direction.

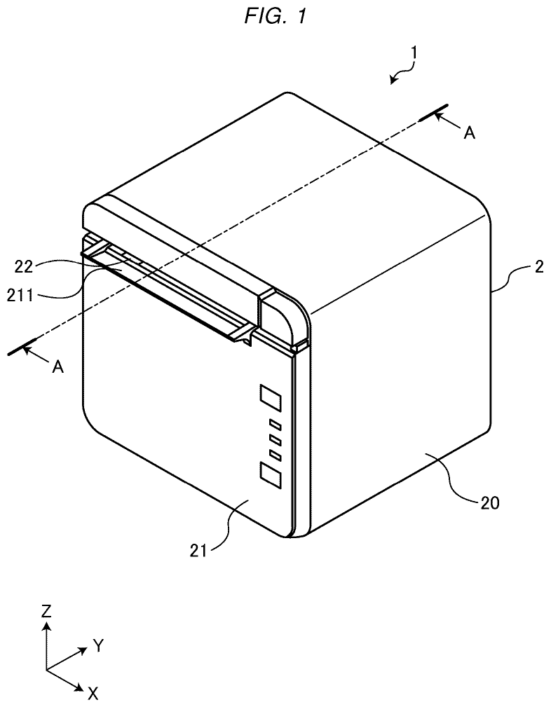

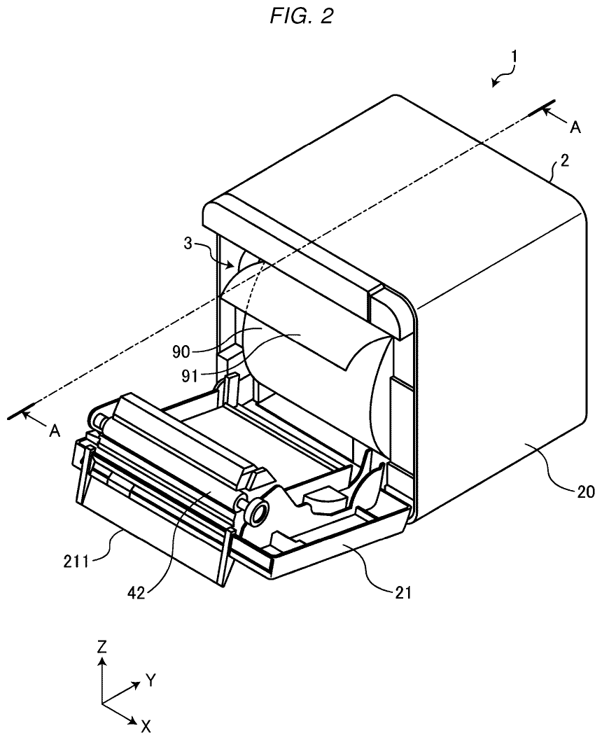

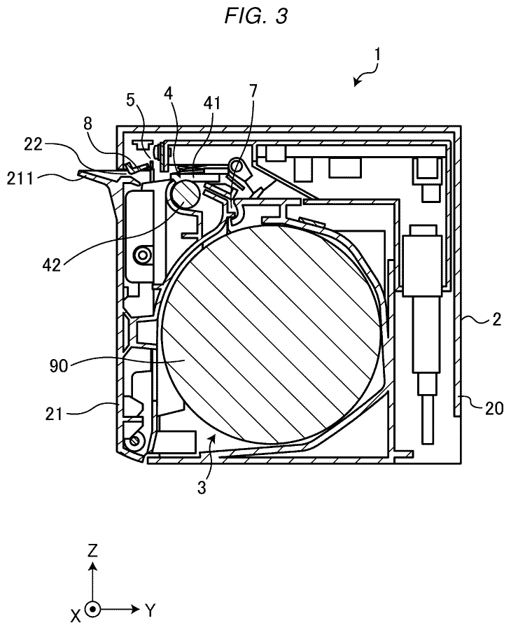

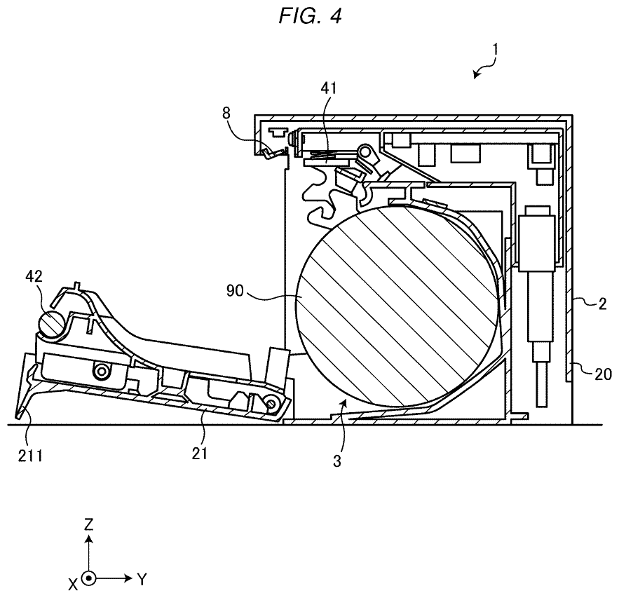

The embodiment will be described with reference to the drawings. FIG. 1 is a perspective view showing an example of appearance of a printer apparatus 1 according to the embodiment. FIG. 2 is a perspective view showing the printer apparatus 1 in a state in which a housing 2 is opened. FIG. 3 is a cross-sectional view showing an example of an internal structure of the printer apparatus 1. FIG. 4 is a cross-sectional view showing the printer apparatus 1 in the state in which the housing 2 is opened. FIGS. 3 and 4 are cross-sectional views of the printer apparatus 1 taken along the lines A-A in FIGS. 1 and 2.

The printer apparatus 1 includes the housing 2, a paper storage portion 3, a printing portion 4, a cutting portion 5, a buffer portion 7, and a swing portion 8. In the drawings, an X-axis direction indicates a width direction (left-right direction) of the printer apparatus 1, a Y-axis direction indicates a depth direction (front-rear direction) of the printer apparatus 1, and a Z-axis direction indicates a height direction (up-down direction) of the printer apparatus 1. A positive direction of the Z-axis is upward from a bottom of the printer apparatus 1. A positive direction of the Y-axis is a direction from a front side to a rear side of the printer apparatus 1. A positive direction of the X-axis is a direction from left to right when the printer apparatus 1 is viewed in the positive direction of the Y-axis.

The printer apparatus 1 according to the embodiment is a thermal printer and is used as a receipt printer for printing (printing, outputting, issuing) receipts, for example.

The housing 2 houses other portions (the paper storage portion 3, the printing portion 4, the cutting portion 5, the buffer portion 7, the swing portion 8, and the like). The housing 2 is box-shaped and has a lid 21 for opening and closing a main body 20 on a front surface. As shown in FIG. 3, the lid 21 in the embodiment has a lower side portion pivotably supported by an edge of an opening of the main body 20, and opens and closes the opening of the main body 20 according to pivoting. In a state in which the lid 21 closes the main body 20, as shown in FIG. 1, a paper discharge port 22 is formed between an upper side of the lid 21 and the edge of the opening of the main body 20. The paper discharge port 22 is an opening for discharging paper 91 from the housing 2.

The lid 21 of the printer apparatus 1 has a support portion 211 at an upper side portion. The support portion 211 is provided downstream of the cutting portion 5 in a paper conveying direction and has an inclined surface that comes into contact with a back surface of a printed surface of the paper 91 to support the paper 91. The inclined surface displaces a leading end portion of the paper 91, which moves along with conveyance, in a direction from the back surface of the paper 91 toward the printed surface.

More specifically, the support portion 211 is located outside the paper discharge port 22 and supports a lower side of the paper 91 discharged from the paper discharge port 22. The support portion 211 is detachably attached to the paper discharge port 22 or is provided integrally with the paper discharge port 22. That is, the support portion 211 is detachably formed at the lid 21 or integrally formed with the lid 21. The support portion 211 may be referred to as a table.

The paper storage portion 3 stores roll paper 90 such that the paper 91 can be pulled out from the roll paper 90. The roll paper 90 is formed by winding the strip-shaped paper 91 with a first surface facing outward. The first surface in the embodiment is a surface where printing is performed (that is, the printed surface). Therefore, an outer peripheral surface of the roll paper 90 is the printed surface of the paper 91. The back surface of the printed surface is an example of a second surface. The paper 91 is an example of a sheet-shaped printing medium. In a state in which the lid 21 is located at a position where the main body 20 is opened, the paper storage portion 3 is opened and the roll paper 90 can be replaced or added.

The printer apparatus 1 performs printing on the paper 91 while pulling out and conveying the paper 91 from the roll paper 90 stored in the paper storage portion 3.

The buffer portion 7 functions as a so-called damper and absorbs tension applied to the paper 91 until the roll paper 90 starts to rotate stably as the paper 91 starts to be conveyed. Accordingly, the buffer portion 7 stabilizes printing of the printing portion 4.

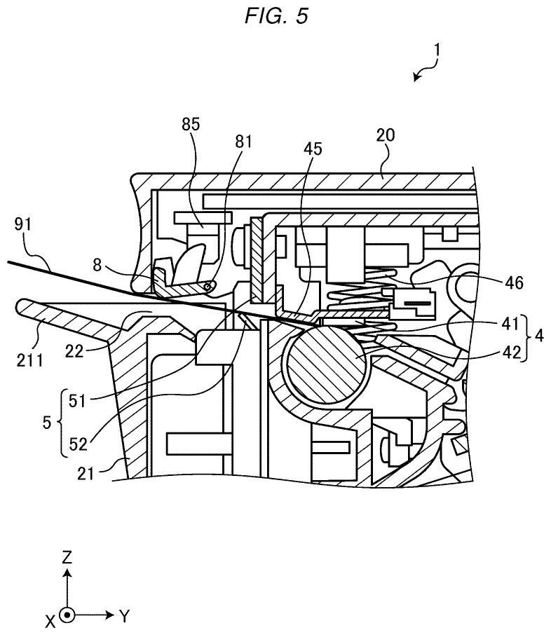

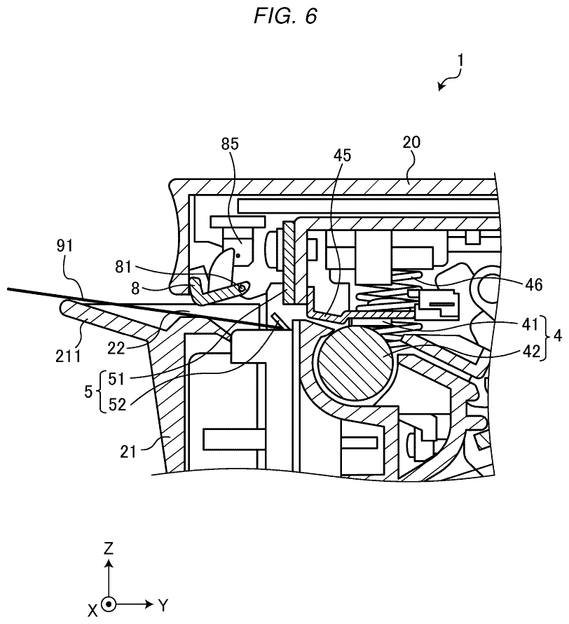

Here, FIGS. 5 and 6 are enlarged cross-sectional views showing a portion around the paper discharge port 22, FIG. 5 shows a state before cutting the paper 91, and FIG. 6 shows a state after cutting the paper 91.

The printing portion 4 performs printing on the paper 91 while pulling out and conveying the paper 91 from the roll paper 90 formed by winding the strip-shaped paper 91, and includes a print head 41 and a platen 42. The print head 41 is provided at the main body 20, and the platen 42 is provided at the lid 21. The platen 42 in the embodiment is a roller and is rotationally driven to convey the paper 91 interposed between the platen 42 and the print head 41.

The print head 41 is a thermal head having a structure in which a plurality of heat-generating elements are aligned. The print head 41 performs printing on the paper 91 interposed between the platen 42 and the print head 41 by causing a heat-generating element corresponding to a printing pattern to generate heat.

More specifically, the print head 41 is attached to the support portion 45, and the print head 41 is disposed at a position facing the platen 42. The support portion 45 is biased by an elastic force of a spring 46 in a direction in which the print head 41 is pressed against the platen 42. Accordingly, the print head 41 is biased in a direction in which the print head 41 is pressed against the platen 42.

When replenishing or replacing the roll paper 90, a user opens the lid 21, replenishes or replaces the roll paper 90, interposes the leading end portion of the paper 91 pulled out from the roll paper 90 between the platen 42 and the print head 41, and closes the lid 21. Accordingly, the leading end portion of the paper 91 is held by the platen 42 and the print head 41.

The cutting portion 5 is provided downstream of the printing portion 4 in the paper conveying direction, is configured to cut the paper 91, and includes a fixed blade 51 and a movable blade 52. The movable blade 52 is a blade movable in a thickness direction of the paper. A moving mechanism for moving the movable blade 52 moves the movable blade 52 in the up-down direction (Z-axis direction) in the drawing under the control of a control unit mounted in the printer apparatus 1. The fixed blade 51 is provided at a position facing the movable blade 52 at a fixed position in the main body 20.

When printing on the paper 91 is completed, the movable blade 52 moves from a back side of the paper to a front side of the paper 91, and the paper 91 is interposed between the moved movable blade 52 and the fixed blade 51, whereby the paper 91 is cut. The front side of the paper 91 corresponds to, for example, the printed surface of the paper 91. The back side of the paper 91 corresponds to a side opposite to the printed surface (non-printed surface) of the paper 91.

Use of the cutting portion 5 is not limited to cutting (full cutting) the paper 91. For example, the cutting portion 5 can also execute partial cutting for cutting a part of the paper 91. The full cutting and the partial cutting are set in advance via an operation portion (not shown) according to an instruction of the user.

The swing portion 8 is an example of a holding portion. The holding portion is provided at a position downstream of the cutting portion 5 in the paper conveying direction and upstream of the paper discharge port 22, and presses the first surface (printed surface) of the paper 91 supported by the support portion 211.

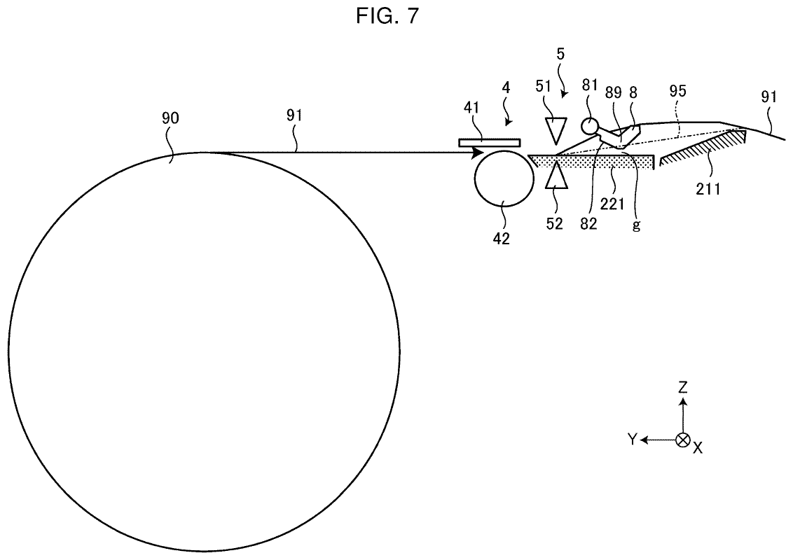

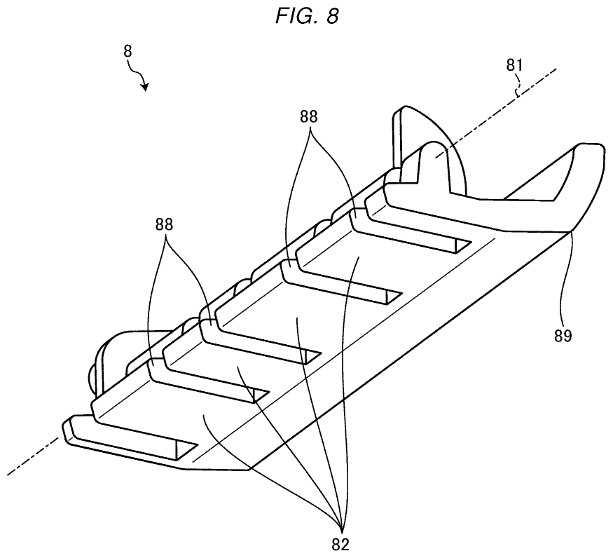

FIG. 7 is a schematic view showing an operation of the swing portion 8. FIG. 8 is a perspective view showing an example of appearance of the swing portion 8. The swing portion 8 has a flap-like shape elongated in a paper width direction, and includes a shaft 81, a guide surface 82, a groove 88, and a bent portion 89.

The shaft 81 is a center of swinging of the swing portion 8 and extends along a longitudinal direction of the swing portion 8. The swing portion 8 is pivotable (swingable) around the shaft 81. The swing portion 8 may be referred to as a flapper.

The bent portion 89 has a shape bent in a valley fold along a crease line parallel to the shaft 81. The bent portion 89 is an example of a pressing portion, and is located downstream of the shaft 81 in the paper conveying direction. The bent portion 89 is a lower end portion of the swing portion 8. That is, the bent portion 89 is a lowest portion of the swing portion 8. The bent portion 89 is located at a portion away from the shaft 81 (for example, in the vicinity of an opposite side of the shaft 81 when the shaft 81 is provided on one side of the swing portion 8), and moves significantly along with pivoting around the shaft 81.

The guide surface 82 is at least a part of a surface of the swing portion 8 facing the paper 91 (lower surface) and is located upstream of the bent portion 89 in the paper conveying direction. The guide surface 82 is a portion with which the leading end and the printed surface of the conveyed paper 91 come into contact, defines a traveling direction of the paper 91, and guides the paper 91 in a predetermined direction. As the conveyance of the paper 91 progresses, the leading end of the paper 91 moves downstream in the paper conveying direction along the guide surface 82. The guide surface 82 in the embodiment is inclined such that the paper 91 is directed downward toward a downstream side in the conveying direction. The guide surface 82 may not be flat and may be, for example, a curved surface.

The groove 88 is elongated along the paper conveying direction and is partially provided at the swing portion 8. The groove 88 is provided, for example, to hold a side end portion of the paper 91 to allow release of a paper holder that defines a width direction position of the paper 91.

Such a swing portion 8 holds (presses) the first surface of the paper 91 due to an action of own weight thereof. A force pushing up the swing portion 8 against such a pressing force is hereinafter referred to as a push-up force. When the push-up force exceeds the pressing force, the swing portion 8 swings by pivoting around the shaft 81.

Here, the printer apparatus 1 includes a sensor 85 that detects the swing portion 8 swinging more than a predetermined level. When the paper 91 is jammed in the vicinity of the paper discharge port 22 and a jam occurs, the swing portion 8 swings significantly and a movement amount (or a pivoting angle) thereof exceeds the predetermined level. When the sensor 85 provided in the printer apparatus 1 detects the swing portion 8 that swings significantly beyond the predetermined degree, the control unit of the printer apparatus 1 determines that a jam has occurred. The control unit includes a central processing unit (CPU), a read only memory (ROM), a random access memory (RAM), and the like, and implements a predetermined functional unit by the CPU loading a program stored in the ROM or the like into the RAM and executing the program.

It is appropriate that the pressing force by the swing portion 8 is sufficiently larger than the push-up force due to stiffness of about a single sheet of the paper 91, and does not exceed the push-up force when the jam occurs.

The swing portion 8 also serves a role by providing another function. The other function is a function of holding the cut paper 91 on the support portion 211 (paper holding function).

Here, the printer apparatus 1 includes a support portion 221. The support portion 221 is located inside the paper discharge port 22 and supports the paper 91 from below in a section from downstream of the printing portion 4 to immediately before the paper discharge port 22 via the cutting portion 5. Behind the support portion 221, the support portion 211 supports the lower surface of the paper 91 after the paper discharge port 22. The support portion 221 and the support portion 211 in the example shown in FIG. 7 are substantially flat surfaces, and an angle formed therebetween is an obtuse angle.

A position of the swing portion 8 shown in FIG. 7 is an initial position. In order to support the paper 91 between the swing portion 8 and the support portion 211, desired positions and operations are set. As the paper 91 is discharged, the paper 91 and the swing portion 8 interfere with each other. When the push-up force of the paper 91 exceeds the pressing force of the swing portion 8, the swing portion 8 moves (swings) from the initial position.

The swing portion 8 holds a rear end of the cut paper 91 on the downstream side in the conveying direction between the swing portion 8 and an upper surface (inclined surface) of the support portion 211 to prevent the paper 91 from falling from the paper discharge port 22. The swing portion 8 does not need to be pressed against the support portion 211 to hold the paper 91, and faces the support portion 211 with a predetermined gap g between the support portion 211 and the lower end portion (bent portion 89).

Since the paper 91 is curved according to a diameter of the roll paper 90 and has stiffness according to a thickness or the like, in a state in which the paper 91 is cut and placed on the support portion 221 and the support portion 211, a center portion in a length direction is separated from the upper surface of the support portion 211 and maintains the curved state. When the swing portion 8 operates to hold the paper 91 in a direction in which the curve is weakened and approaches the upper surface of the support portion 211, the paper 91 receives the pressing force of the swing portion 8 and the swing portion 8 receives the push-up force due to the stiffness of about a single sheet of the paper 91. Accordingly, the paper 91 is held between the swing portion 8 and the support portion 211.

With such a shape and arrangement of the swing portion 8, the leading end of the paper 91 is guided by the guide surface 82 and reaches the gap g between the bent portion 89 and the support portion 221. Then, the paper 91 passes through the gap g between the bent portion 89 and the support portion 221, exits from the paper discharge port 22 and reaches the support portion 211.

An imaginary line 95 indicated by a two-dot dashed line connects a downstream end portion of the support portion 211 in the paper conveying direction and a position where the paper 91 is cut by the cutting portion 5 (upstream of the support portion 221 in the paper conveying direction). In the embodiment, the imaginary line 95 is used as a reference for setting the initial position of the swing portion 8.

The support portion 211 is inclined to be located higher toward the downstream side in the paper conveying direction in order to make it less likely for the paper 91 having a length hanging down beyond a tip of the support portion 211 to fall. The inclination of the support portion 211 is steeper than that of the imaginary line 95. Accordingly, the upper surface of the support portion 211 and an upper surface of the support portion 221 form an obtuse angle.

The bent portion 89 located at the initial position interferes with (intersects) the imaginary line 95. Since the upper surface of the support portion 211 and the upper surface of the support portion 221 form an obtuse angle, a space including the gap g described above is formed between the imaginary line 95 and the upper surfaces of the support portion 211 and the support portion 221.

In the printer apparatus 1 according to the embodiment, the cut paper 91 is placed on the support portion 221 and the support portion 211 in a state in which the center portion is curved in a high mountain-like shape. In the schematic diagram in FIG. 7, the swing portion 8 and the curved paper 91 that is not held by the swing portion 8 are shown in an overlapping manner (in an intersecting state), but in practice, the paper 91 is located near the imaginary line 95 since the swing portion 8 holds the paper 91 from above.

More specifically, since the paper 91 is curved according to the diameter of the roll paper 90 and has stiffness, the paper 91 on the support portion 211 is kept in a curved state with the center portion in the length direction separated from the upper surface of the support portion 211. The swing portion 8 holds the paper 91 in a direction in which the curve is weakened and approaches the upper surface of the support portion 211. More specifically, a degree of curvature of the paper 91 is considered to be close to or less than a curved state immediately before the paper 91 is pulled out from the roll paper 90. With such an arrangement, the swing portion 8 can apply an appropriate pressing force to the paper 91 such that the paper 91 does not fall from the support portion 211.

In this way, according to the embodiment, it is possible to provide the printer apparatus 1 that makes it less likely for the cut and discharged paper 91 to fall by using the swing portion 8 which is not a consumable like a brush.

The above-described embodiment can be appropriately modified and implemented by changing a part of configurations or functions of each described apparatus above. Modifications will be described below. In description of the modifications, portions different from those in the above-described embodiment will be mainly described, and portions common to those in the embodiment are denoted by the same reference signs, and detailed description thereof will be omitted.

### First Modification

In implementation, there may be a step or an uneven shape between the shaft 81 and the guide surface 82. That is, a portion between the shaft 81 and the guide surface 82 may not be flat.

For example, it may be difficult to flatten a portion connecting the shaft 81 to the guide surface 82 due to constraints related to a method or a process (as an example, a constraint related to a mold) for manufacturing the swing portion 8, and a step may be provided at this portion. In addition, for example, in order to reduce an influence due to friction with the paper 91, an uneven shape such as a rib may be provided on a surface (including the guide surface 82) of the swing portion 8 to reduce a contact area with the paper 91. There is no intention to exclude these cases in implementation.

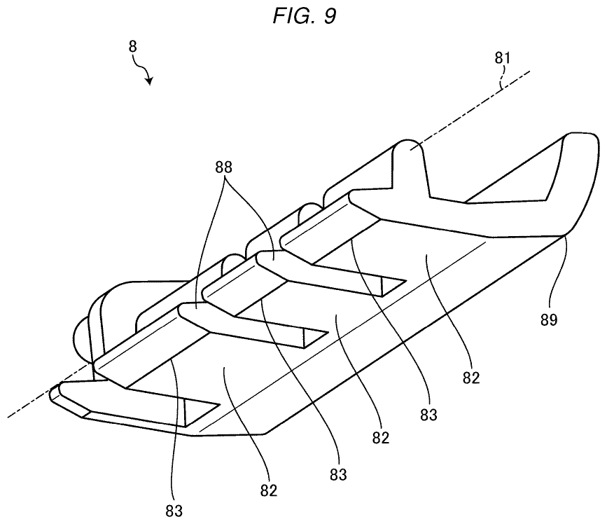

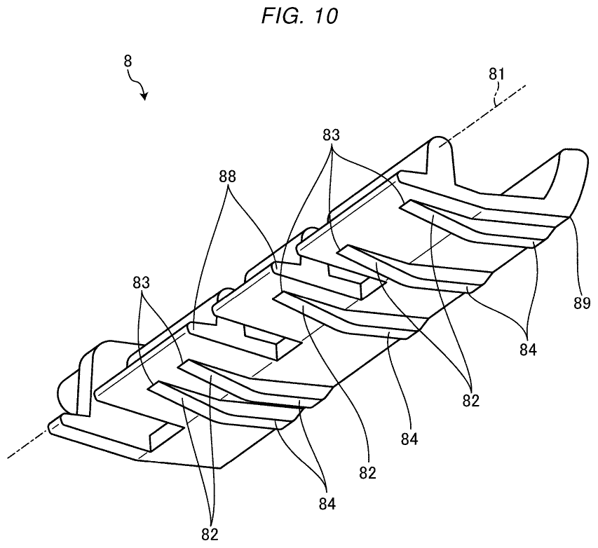

For example, in the example in FIG. 7, a concave shape is provided between the shaft 81 and the guide surface 82, and alternatively, a convex shape may be provided. Another example is shown in FIGS. 9 and 10 described below.

FIG. 9 is a perspective view showing another example of the appearance of the swing portion 8. The swing portion 8 includes a switching portion 83 upstream of the guide surface 82 in the paper conveying direction. The switching portion 83 is an example of the above-described step or uneven shape between the shaft 81 and the guide surface 82. The shown switching portion 83 is a boundary portion where a surface direction is switched between the guide surface 82 and the vicinity thereof, and in implementation, a shape of the switching portion 83 may be a groove shape along the paper width direction or a stepped shape.

FIG. 10 is a perspective view showing another example of the appearance of the swing portion 8. The swing portion 8 has a rib 84, and the guide surface 82 is provided at the rib 84. A rear end (an upstream end in the paper conveying direction) of the rib 84 corresponds to the switching portion 83. The rib 84 is provided to reduce friction between the paper 91 and the swing portion 8, to reinforce the swing portion 8, and the like.

The swing portion 8 shown in FIGS. 9 and 10 can also obtain the effects of the swing portion 8 shown in FIGS. 7 and 8.

### Second Modification

In implementation, the initial position of the swing portion 8 is not limited to the example in FIG. 7. For example, the bent portion 89 may be located above the example in FIG. 7, and more specifically, may be located between the imaginary line 95 and the curved paper 91 that is not held by the swing portion 8. A curved state of the paper 91 assumed in this case is a state in which a peak height is lowest among assumed states, and is, for example, a state of the paper 91 pulled out from the roll paper 90 having a maximum diameter used in the printer apparatus 1.

With such a configuration, substantially the same effects as those of the configuration shown in FIG. 7 can still be obtained.

### Third Modification

Next, the upper surfaces of the support portion 211 and the support portion 221 may not be two surfaces forming the obtuse angle as in FIG. 7, and may form, for example, concave curved surfaces that are adjacent and smoothly continuous. With such a configuration, the same imaginary line 95 is set, the swing portion 8 is disposed at a position where the lower end portion (bent portion 89) interferes with (intersects) the imaginary line 95, and thus the same effects as those of the configuration in FIG. 7 can still be obtained.

### Fourth Modification

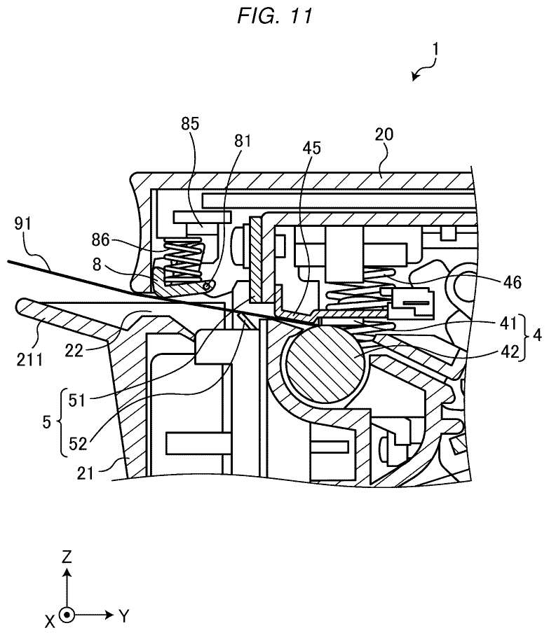

FIG. 11 is an enlarged cross-sectional view of the portion around the paper discharge port 22. The swing portion 8 in this modification includes a biasing member 86 such as a spring. The biasing member 86 biases the swing portion 8 in a direction in which the paper 91 is pressed, and applies a load to pivoting of the swing portion 8 around the shaft 81. This load is for normally operating the swing portion 8 when a paper discharge direction of the printer apparatus 1 is changed from the front to an upward direction. The swing portion 8 is located at the initial position when there is no interference with the paper 91, and receives a load against biasing of the biasing member 86 from the paper 91 as paper is discharged (the paper 91 is discharged).

When an installation orientation assumed for the printer apparatus 1 is fixed, it is possible to design the swing portion 8 to operate by the own weight thereof as in the above-described embodiment. However, the printer apparatus 1 is not limited to the state in which the paper 91 is discharged forward as shown in FIG. 1, and if the printer apparatus 1 can be installed with the paper discharge port 22 facing upward to discharge the paper 91 upward, a design that does not affect the operation of the swing portion 8 even when the orientation of the printer apparatus 1 relative to a vertical direction is changed is required.

As in this modification, by providing the biasing member 86 that provides a biasing force to replace the pressing force in the above-described embodiment, the swing portion 8 can be designed to allow the change in the 1 relative to the orientation of the printer apparatus vertical direction.

While certain embodiments have been described, these embodiments have been presented by way of examples only, and are not intended to limit the scope of the disclosure. The novel embodiments described herein may be embodied in a variety of other forms, and various omissions, substitutions, changes, and combinations may be made without departing from the gist of the disclosure. The embodiments and the modifications thereof are included in the scope and the gist of the disclosure, and are included in the scope of the disclosure disclosed in the claims and equivalents thereof.

What is claimed is:

1. A printer apparatus, comprising:
a printing component configured to perform printing while pulling out and conveying strip-shaped paper from roll paper formed by winding the strip-shaped paper with a first surface facing outward;
a cutting component provided downstream of the printing component in a paper conveying direction and configured to cut the strip-shaped paper;
a support component provided downstream of the cutting component in the paper conveying direction and configured to come into contact with a second surface that is a back surface of the first surface to support the strip-shaped paper, the support component being inclined such that a leading end portion of the strip-shaped paper, which moves along with conveyance, is displaced in a direction from the second surface toward the first surface; and
a holding component provided downstream of the cutting component in the paper conveying direction and configured to press the first surface of the strip-shaped paper supported by the support component.

2. The printer apparatus according to claim 1, wherein
the holding component includes a shaft at an end portion on an upstream side in the paper conveying direction, is swingable around the shaft, and presses the strip-shaped paper by a pressing component that is a portion downstream of the shaft in the paper conveying direction.

3. The printer apparatus according to claim 2, wherein
the holding component is biased in a direction in which the pressing component presses the strip-shaped paper.

4. The printer apparatus according to claim 1, wherein
inclination of the support component is steeper than that of an imaginary line connecting a tip of the support component and a cutting position of the cutting component, and
the holding component is located at a position where the holding component interferes with the imaginary line when the strip-shaped paper does not touch the holding component.

5. The printer apparatus according to claim 1, wherein
the support component has a concave curved surface.

6. The printer apparatus according to claim 1, wherein
the cutting component comprises a fixed blade and a movable blade, the movable blade configured to move in a thickness direction of the strip-shaped paper.

7. The printer apparatus according to claim 1, further comprising:
a swing component configured to hold the strip-shaped paper in a direction in which a curve of the strip-shaped paper is weakened and approaches an upper surface of the support component, the strip-shaped paper receives a pressing force from the swing component and the swing component receives a push-up force from the strip-shaped paper.

8. A method for a printer, comprising:
printing while pulling out and conveying strip-shaped paper from roll paper formed by winding the strip-shaped paper with a first surface facing outward;
cutting the strip-shaped paper using a cutting component provided downstream of a printing component in a paper conveying direction;
contacting a support component provided downstream of the cutting component in the paper conveying direction with a second surface that is a back surface of the first surface to support the strip-shaped paper, the support component being inclined such that a leading end portion of the strip-shaped paper, which moves along with conveyance, is displaced in a direction from the second surface toward the first surface; and
pressing the first surface of the strip-shaped paper supported by the support component using a holding component provided downstream of the cutting component in the paper conveying direction.

9. The method according to claim 8, wherein
the holding component includes a shaft at an end portion on an upstream side in the paper conveying direction, is swingable around the shaft, and presses the strip-shaped paper by a pressing component that is a portion downstream of the shaft in the paper conveying direction.

10. The method according to claim 9, wherein
the holding component is biased in a direction in which the pressing component presses the strip-shaped paper.

11. The method according to claim 8, wherein
inclination of the support component is steeper than that of an imaginary line connecting a tip of the support component and a cutting position of the cutting component, and
the holding component is located at a position where the holding component interferes with the imaginary line when the strip-shaped paper does not touch the holding component.

12. The method according to claim 8, wherein
the support component has a concave curved surface.

13. The method according to claim 8, further comprising:
moving a movable blade in a thickness direction of the strip-shaped paper.

14. A thermal printer, comprising:
a thermal printing component comprising a thermal print head and configured to perform printing while pulling out and conveying strip-shaped paper from roll paper formed by winding the strip-shaped paper with a first surface facing outward;
a cutting component provided downstream of the thermal printing component in a paper conveying g direction and configured to cut the strip-shaped paper;
a support component provided downstream of the cutting component in the paper conveying direction and configured to come into contact with a second surface that is a back surface of the first surface to support the strip-shaped paper, the support component being inclined such that a leading end portion of the strip-shaped paper, which moves along with conveyance, is displaced in a direction from the second surface toward the first surface; and
a holding component provided downstream of the cutting component in the paper conveying direction and configured to press the first surface of the strip-shaped paper supported by the support component.

15. The thermal printer according to claim 14, wherein
the holding component includes a shaft at an end portion on an upstream side in the paper conveying direction, is swingable around the shaft, and presses the strip-shaped paper by a pressing component that is a portion downstream of the shaft in the paper conveying direction.

16. The thermal printer according to claim 15, wherein
the holding component is biased in a direction in which the pressing component presses the strip-shaped paper.

17. The thermal printer according to claim 14, wherein
inclination of the support component is steeper than that of an imaginary line connecting a tip of the support component and a cutting position of the cutting component, and
the holding component is located at a position where the holding component interferes with the imaginary line when the strip-shaped paper does not touch the holding component.

18. The thermal printer according to claim 14, wherein
the support component has a concave curved surface.

19. The thermal printer according to claim 14, wherein
the cutting component comprises a fixed blade and a movable blade, the movable blade configured to move in a thickness direction of the strip-shaped paper.

20. The thermal printer according to claim 14, further comprising:
a swing component configured to hold the strip-shaped paper in a direction in which a curve of the strip-shaped paper is weakened and approaches an upper surface of the support component, the strip-shaped paper receives a pressing force from the swing component and the swing component receives a push-up force from the strip-shaped paper.
